(19) United States
(12) Patent Application Publication
(10) Pub. No.: US 2009/0037273 A1
(43) Pub. Date: Feb. 5, 2009

(54) Systems and methods for displaying advertisement information

(76) Inventor: Jian Zhu, Washington, NC (US)

Correspondence Address: OLIFF & BERRIDGE, PLC, P.O. BOX 320850, ALEXANDRIA, VA, 22320-4850, US

(21) Appl. No.: 11/882,209

(22) Filed: Jul. 31, 2007

(51) Int. Cl. G06Q 30/00; G01S 1/02; G09G 5/00

(52) U.S. Cl. 705/14; 342/357.06; 345/2.1

(57) ABSTRACT

An advertisement system is provided for displaying advertisement information. The system includes a movable apparatus configured to move at various speeds from various starting locations to various ending locations along various routes. The movable apparatus includes a display assembly that has at least one display screen. The display screen faces away from the movable apparatus and displays advertisement information for public viewers outside the movable apparatus to view. A controller selects a piece of advertisement information from a plurality of pieces of advertisement information to display on the display screen. The selected piece of advertisement information is irrelevant to the starting locations, the ending locations, and the routes of the first movable apparatus.

### BACKGROUND

This application relates to systems and methods for displaying advertisement information. In particular, this application relates to systems and methods for displaying advertisement information using display devices provided on movable apparatuses, such as trucks, buses, cars, boats and blimps.

Advertisements have been displayed on a variety of media, such as billboards, buildings and vehicles. More approaches need to be explored and utilized to display advertisement information.

### SUMMARY

An advertisement system is provided for displaying advertisement information. The system includes a first movable apparatus that is configured to move at various speeds. The first movable apparatus includes: a first front portion; a first rear portion that is opposite to the first front portion; a first left-hand side portion on a left-hand side periphery of the first movable apparatus between the first front portion and first rear portion, and a first right-hand side portion on a right-hand side periphery of the first movable apparatus between the first front portion and first rear portion. At least one of the first front portion, the first rear portion, the first left-hand side portion and the first right-hand side portion is provided with a first display assembly. The first display assembly has at least one first display screen. The at least one first display screen faces away from the first movable apparatus and displays advertisement information for public viewers outside the first movable apparatus to view. The advertisement information includes contents that promote a product, a service or a cause. The system includes a storage that stores a plurality of pieces of advertisement information; and a controller that selects a first piece of advertisement information from the plurality of pieces of advertisement information for the first display assembly to display on the at least one first display screen.

These and other features and details are described in, or are apparent from, the following detailed description.

### BRIEF DESCRIPTION OF THE DRAWINGS

Various exemplary details of systems and methods are described, with reference to the following figures, wherein:

FIG. 1 shows an embodiment of an advertisement system for displaying advertisement information;

FIG. 2 illustrates an exemplary movable apparatus used in the system shown in FIG. 1;

FIG. 3 shows an exemplary movable apparatus having a display assembly used in the system shown in FIG. 1;

FIG. 4 shows an exemplary embodiment of a display assembly used in the system shown in FIG. 1;

FIGS. 5 and 6 show two different embodiments of a display assembly used in the system in FIG. 1;

FIG. 7 is a flowchart illustrating a first exemplary method for displaying advertisement information;

FIG. 8 is a flowchart illustrating a second exemplary method for displaying advertisement information;

FIG. 9 is a flowchart illustrating a third exemplary method for displaying advertisement information; and

FIG. 10 is a functional block diagram of an exemplary embodiment of a controller used in the system shown in FIG. 1.

### DETAILED DESCRIPTION OF EMBODIMENTS

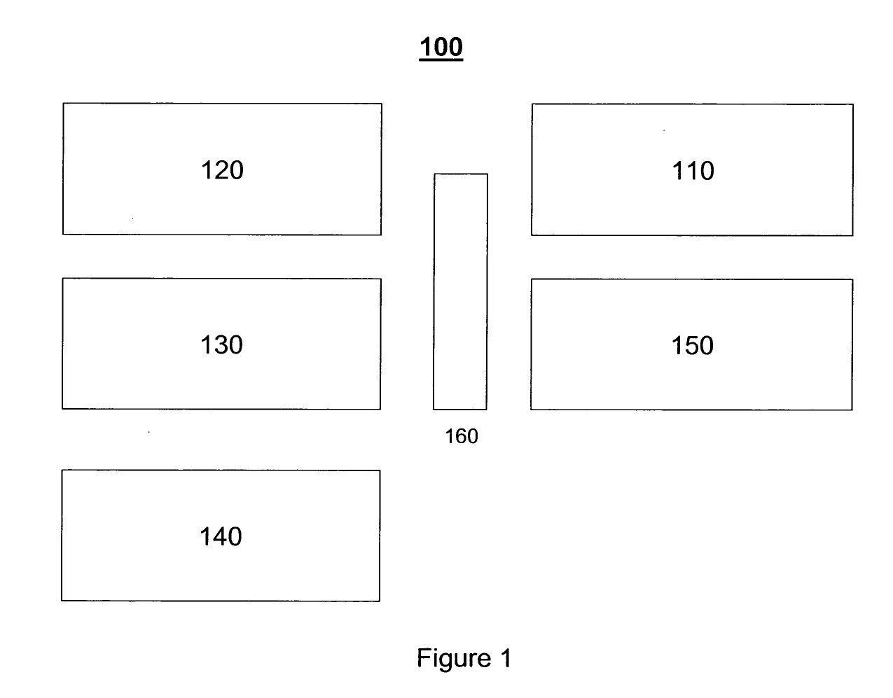

FIG. 1 illustrates a general configuration of an exemplary embodiment of an advertisement system for displaying advertisement information. As shown in FIG. 1, the advertisement system 100 may include a controller 110, a plurality of movable apparatuses 120 and 130, a non-movable apparatus 140, and a storage 150.

The movable apparatuses 120 and 130 may move independently from each other. The movable apparatus 120 may move at a first speed, while the movable apparatus 130 may move at a second speed that is different from the first speed. Also, the first and second speeds may both be a variable, and the first speed may vary in a fashion that is different from that in which the second speed varies.

The movable apparatuses 120 and 130 may be located at different places. For example, the movable apparatus 120 may be moving, at a certain time, around the Capital Hill in Washington, D.C. At the same time, the movable apparatus 130 may be moving near Williamsburg, Va.

The movable apparatuses 120 and 130 may each be an automobile vehicle, such as a sedan car, a bus, a truck such as an 18-wheeler, or the like. Also, the movable apparatuses 120 and 130 may each be a car of a locomotive. Furthermore, the movable apparatuses 120 and 130 may each be a water-carried vehicle, such as a boat, or the like. Additionally, the movable apparatuses 120 and 130 may each be an airborne object, such as an airplane, a blimp, or the like.

The non-movable apparatus 140 may be a billboard erected alongside a highway, a display device on an outer wall of a building, or the like.

The storage 150 stores advertisement information. The advertisement information may include a plurality of pieces of advertisement information. The pieces of advertisement information may be categorized into different categories, such as food, hotel, sports, and the like. Each piece of advertisement information may also include a geographical component that indicates the geographical locations at which a particular piece of advertisement information is intended to be displayed.

The pieces of advertisement information may be organized in a searchable database provided on the storage 150. The database may be searched by using categories and the geographical component, for example. The pieces of advertisement information may also each include a time component to indicate a time or times at which a particular piece of advertisement information is intended to be displayed. Such a time component may also be searchable as a feature of the searchable database on the storage 150.

The storage 150 may be located at a location different from apparatuses 120-140 and the controller 110. The storage 150 may also be located on one of the controller 110 and the apparatuses 120-140. The storage 150 may have plural components located at different locations.

The controller 110 obtains pieces of advertisement information from the storage 150, and displays the obtained pieces of advertisement information at apparatuses 120-140. As will be discussed in greater details below, the controller 110 may coordinate the selection of pieces of advertisement information to be displayed on apparatuses 120-140. For example, the controller 110 may select the same piece of advertisement information to be displayed at apparatuses 120-140 in a time sequence that forms a temporal pattern. Also, the controller 110 may select a piece of advertisement information to be displayed at movable apparatus 120 based on the geographical location of movable apparatus 120, using the geographical component of the selected piece of advertisement information. Similarly, the controller 110 may select a piece of advertisement information to be displayed at movable apparatus 120 according to the time of day of the display, using the time component of the selected piece of advertisement information.

When the controller 110 coordinates the advertisement displays among apparatuses 120-140, the advertisement system 100 forms a networked advertisement system.

As will be discussed in greater detail below, each of apparatuses 120-140 may have a plurality of display panels that may display, at the same time, different pieces of advertisement information. The controller 110 may also coordinate the display of the plurality of display panels on one movable apparatus, for example.

Additionally, as will be discussed in greater detail below, when a piece of advertisement information selected to be displayed at movable apparatus 120 is a video clip having a plurality of video frames that are displayed in an animated fashion at a predetermined frame change rate, the controller 110 may change the predetermined frame change rate based on the speed of the movable apparatus 120, so as to enhance readability of the displayed advertisement information to a viewer. For example, if the movable apparatus 120 is moving at a significant speed, the controller 110 may reduce the frame change rate of the video clip so that the displayed information can still be readable by a human eye.

The controller 110 may be located at a place different from the apparatuses 120-140, and the storage 150. The controller 110 may also be located on one of the apparatuses 120-140 or at the storage 150. The controller 110 may have plural components located at different locations.

The controller 110 may send advertisement information remotely to the apparatuses 120-140 for display. As will be described in greater detail below, the apparatuses 120-140 may transmit information to the controller 110, using a transmitter. For example, the movable apparatuses 120 and 130 may transmit their respective geographical locations to the controller 110.

When the controller 110 is located at the movable apparatus 120, for example, the transmission between the controller 110 and the movable apparatus 120 may not need to be a remote transmission. However, the transmission between the controller 110 and the movable apparatus 130 may still be a remote transmission.

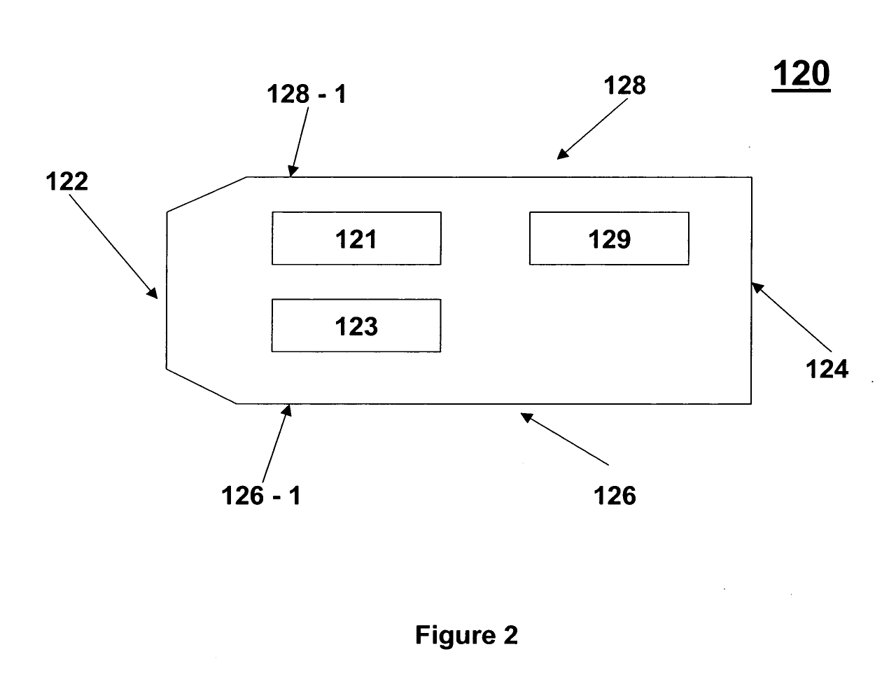

FIG. 2 shows an exemplary embodiment of a movable apparatus 120. As shown in FIG. 2, the movable apparatus 120 has a front portion 122, a rear portion 124, a left-hand side portion 126 on a left-hand side periphery 126-1 between the front portion 122 and the rear portion 124, and a right-hand side portion 128 on a right-hand side periphery 128-1 between the front portion 122 and the rear portion 124.

As discussed above, the movable apparatus 120 may be an automobile vehicle, such as a passenger car, a bus, an 18-wheeler or another type of truck. The movable apparatus 120 may also be a car of a locomotive. The movable apparatus may also be a water-carried vehicle, such as a boat, a ship, or the like. Additionally, the movable apparatus 120 may be an airborne vehicle, such as a blimp, an airplane, a helicopter, or the like.

As shown in FIG. 2, the movable apparatus 120 may have a transmitter 121 that communicates with the controller 110 (see FIG. 1). The transmitter 121 may communicate with the controller 110 in one or more of conventionally known protocols, such as radio frequency, wireless internet, Bluetooth, or the like. The transmitter 121 may both transmit information to and receive information from the controller 110.

The transmitter 121 may send information to the controller, such as the geographical location of the movable apparatus 120, the instant speed of the movable apparatus 120, or the like. Also, the transmitter 121 may send weather information, such as temperature and whether it is sunny, foggy or rainy.

The movable apparatus may also have a GPS (global positioning system) receiver 123 that receives its geographical location information from a GPS system. The geographical location information may be transmitted to the controller 110 by the transmitter 121. For example, the movable apparatus 120 may have a navigation system that receives GPS information of the movable apparatus 120. The GPS receiver 123 may be an integral part of the navigation system. The GPS receiver 123 may also be a separate device that obtains the geographical location information from the navigation system.

The movable apparatus 120 may also have a speed detector 129. For example, the speed detector 129 may be the odometer of the movable apparatus 120. The speed detector may also be a separate device that receives speed information from the odometer. The speed information of the movable apparatus 120 may be transmitted by the transmitter 121 to the controller 110.

The movable apparatus 120 may also have a weather monitor 129-1 that measures weather conditions (for example, temperature, sunny/rainy/snowy/foggy) that may be transmitted by the transmitter 121 to the controller 110. The non-movable apparatus 140 may also have a weather monitor, as well as a transmitter.

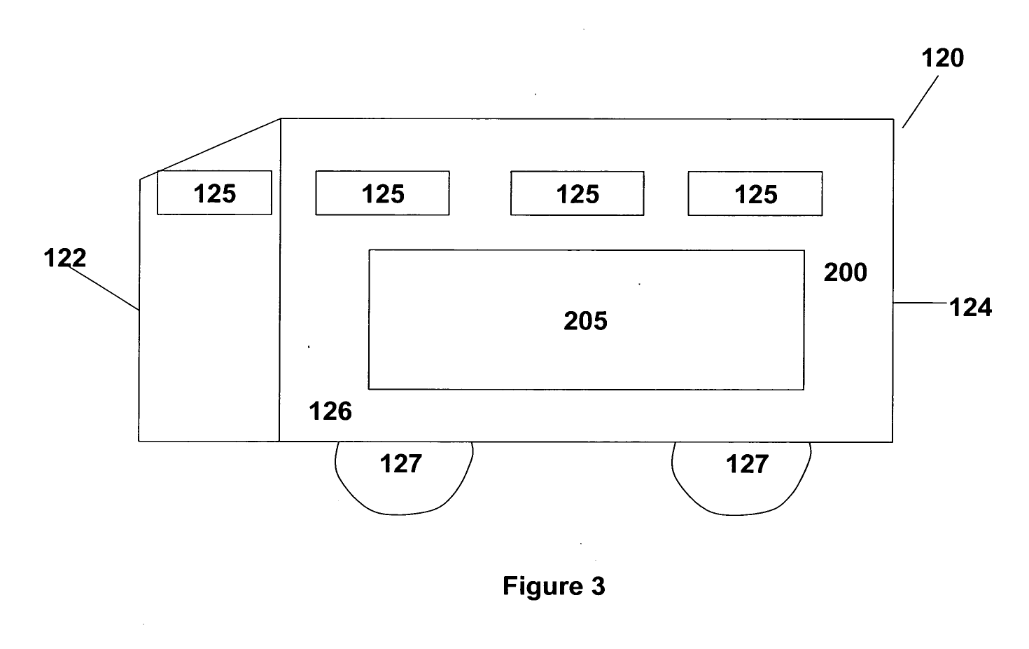

FIG. 3 is another diagram showing an exemplary embodiment of the movable apparatus 120. In this embodiment, the movable apparatus is a minivan, having windows 125 and tires 127. As shown in FIG. 3, a display assembly 200 is provided on the movable apparatus 120.

In FIG. 3, the display assembly 200 includes a display panel 205 on the left-hand side portion 126 of the movable apparatus 120. The display assembly 200 may also have another display panel (not shown) provided on the front portion 122, rear portion 124, or the right-hand side portion 128 of the movable apparatus 120.

In FIG. 3, the display panel 205 is shown to be located on a side periphery of the body of a minivan. However, the display panel 205 may also be located on the top of the minivan. The display panel 205, if provided on a blimp, may also be located at the bottom of the blimp.

As shown in FIG. 3, the display assembly 200 is provided such that the display panel 205 faces away from the movable apparatus 120, so as to be viewed by public viewers outside the movable apparatus 120 when the display panel 205 displays information. For example, as shown in FIG. 3, the display panel 205 provided on the left-hand side periphery of the movable apparatus 120 faces away from the left-hand side of the movable apparatus 120, such that public viewers outside on the left-hand side of the movable apparatus 120 may read the information displayed on the display panel 205.

The information displayed on the display panel 205 is from the controller 110 (see FIG. 1). When the controller 110 is located remotely from the movable apparatus 120, the controller sends information to be displayed to the movable apparatus 120. The movable apparatus 120 receives the information from the controller 110, using the transmitter 121, which functions as a receiver. Alternatively, the receiver that receives information from controller 110 may also be provided as a device separate from transmitter 121.

When the controller 110 is located on the movable device 120, the information exchange between the movable apparatus 120 and the controller 110 may be performed by connections or links therebetween without using the transmitter and/or receiver.

The controller 110 selects information to be displayed from the storage 150. The selection of the information may be based on the information received from the apparatuses 120-140. The received information may include geographical information, speed information, and/or weather information. The selected information is sent to apparatuses 120-140 for display on the display panel 205 for public view.

In FIG. 3, the information displayed on display panel 205 is advertisement information. The advertisement information may be commercial information for promoting a product or a service. For example, the commercial information may include a trademark or a logo of a product or a service. The commercial information may also include contact information, such as a telephone number or a web address for consumers to obtain more information of the product or service.

The advertisement information may also be politically directed information for promoting a political campaign or a political figure. For example, the politically directed information may include a statement that supports a bill to be endorsed by the Congress. Also, the politically directed information may include a statement that voters should vote for a political figure who is running for an office.

The advertisement information may also be civic information for promoting a civic event. For example, the civic information may concern a music event at Wolftrap in Northern Virginia. Also, the civic information may concern a July 4 parade in downtown Fairfax City, Va. The advertisement information may be public interest information for promoting public interest. For example, the public interest information may include traffic condition information, especially during rush hours; weather information; airplane delay and/or cancellation information; educational messages such as “no drugs” and “buckle up” or the like; police emergency alert, such as the happening of a crime at certain location, so as to inform the public to keep away from that location and/or to vacant the location; and/or news from TV stations, for example, that concerns public interest.

The advertisement information may be religious information for promoting a faith. The advertisement information may also be ideological information for promoting a humanitarian cause. For example, the ideological information may be for promoting protection of the environment, for promoting animal rights, for promoting awareness of breast cancer, or the like.

The advertisement information is intended to persuade the public to agree or support the subject matter intended in the advertisement information. For example, the advertisement information may be intended to persuade the public to buy or purchase the product or service promoted in the commercial information; to vote for the candidate that is running for the office; to participate in the musical event or the parade; to observe public interest; to believe in the faith; and/or to support the humanitarian cause. In various exemplary embodiments, the advertisement information is irrelevant to the movable and non-movable apparatuses 120-140. For example, the movable apparatus 120 may be moving from various starting locations to various ending locations along various routes. The advertisement information may be irrelevant to which location the movable apparatus 120 is going to, which location the movable apparatus 120 is coming from, or which route the movable apparatus 120 is moving along.

The advertisement information may be displayed in different formats. For example, the advertisement information may be displayed by text, by image, by slide, by animated sequences of text/images, by video clips, or the like. A video clip may have a sequence of a plurality of frames that are displayed at a predetermined frame change rate or frame change frequency. The frame change rate indicates the number of frames that is displayed sequentially within a period of time, such as a second. The predetermined frame change rate of a video clip may be a conventional frame change rate suitable for a human eye. For example, the predetermined frame change rate may be that of a television set, a DVD player, or the like. The frame change rate may be minimized to avoid excessive number of frames, yet maximized to assure display quality.

The controller 110 may reduce the originally predetermined frame change rate when the movable apparatus 120 is moving at a significant speed, so as to adjust the frame change rate to an adjusted frame change rate, in order to assure that what is displayed is readable by public viewers when the movable apparatus 120 is moving. For example, when the movable apparatus 120 is moving at a speed more than 30 mph, the controller may reduce the frame change rate of the video clip to zero, such that what is displayed is actually a static image. Alternatively, the controller 110 may replace the video clip with another piece of advertisement information that is not a video clip, but a static text or image; or may display a sequence of slides which changes the display of individual slides at a rate slower than the frame change rate of the video clip, so that public viewers can read the content of the slides even when the speed of the movable apparatus 120 is more than 30 mph.

When the speed of the movable apparatus 120 is less than 30 mph, but more than 5 mph, the controller 110 may reduce the frame change rate of the video clip to a reduced, but non-zero rate. This way, the video clip is still displayed, with its frames shown and displayed at a reduced frame change rate to ensure readability to the public viewers.

When the speed of the movable apparatus 120 is less than 5 mph, the controller 110 may decide not to reduce the frame change rate, considering that such a slow speed would not affect the readability of the video clip.

The above example regarding reduction of the predetermined frame change rate of the video clip is only illustrative, and not limiting. In particular, the numbers 5 mph and 30 mph are only used for illustration purposes, and may be adjusted and/or otherwise changed by one skilled in the art. For example, the above-discussed 5 mph may be changed between 2 mph and 10 mph. Likewise, the above-discussed 30 mph may be changed between 20 mph and 50 mph.

Furthermore, in addition to the 5 mph and 30 mph thresholds, more thresholds may be provided at, for example, 10 mph, 15 mph and/or 20 mph, so that the frame change rate may be reduced at different levels.

Also, the above-discussed 5 mph and 30 mph may be further adjusted by the weather condition experienced by the movable apparatus 120. For example, when the weather conditions affect readability of the displayed contents, the controller may reduce the above-discussed 5 mph to 2 or 3 mph, and to reduce the above-discussed 30 mph to 15 or 25 mph, so as to ensure readability of the displayed contents.

Similar to a video clip, the frame exchange rate predetermined for displaying a sequence of animated slides may also be adjusted based on the speed of the movable apparatus 120 and/or the weather condition experienced by the movable apparatus 120.

In FIG. 3, the display panel 205 may be one of any conventionally known displays, such as electronic, electrical, and photoelectrical displays or the like. For example, the display panel may be a plasma display, a LCD display, a LED display, or the like.

In FIG. 3, the display panel 205 is shown to be rectangular. However, the display panel 205 may also be in other shapes, such as square, sphere, oval, diamond, half-sphere, or the like. In various exemplary embodiments, the display panel may have at least a 50×50 array of pixels to ensure display quality. In various exemplary embodiments, the display panel may have a resolution comparable to that of a television set.

The display panel 205 may be a permanent part of the movable apparatus 120. For example, the display panel 205 may be provided as an integral part of the outer periphery of the movable apparatus 120. The display panel 205 may also be provided as a separate component from the outer periphery of the movable apparatus 120 but fixedly mounted on the movable apparatus 120. For example, the display panel 205 may be molded or permanently fixed by adhesive to the outer periphery of the movable apparatus 120.

The display panel 205 may also be replaceably attached to or mounted on the outer periphery of the movable apparatus 205. In particular, the display panel 205 may be mounted by screws, and may be replaced by removing the screws.

Alternatively, the display panel 205 may be detachably attached to the outer periphery of the movable apparatus 120. For example, the display panel 205 may be slid on grooves (not shown) or latches (not shown) provided on the periphery of the movable apparatus 120. In such a configuration, the display panel 205 may be detached by sliding the display panel 205 off the movable apparatus 120, or by unlatching the latches, without removing any parts (even screws). In such a configuration, the display panel 205 may be detached from the movable apparatus 120 by a user using bare hands, without even using a screwdriver.

An interface 160 may be provided to be used in connection with the controller 110, as shown in FIG. 1. The interface 160 may provide a list of options for a user to decide whether to enable the “frame rate change” features discussed above. For example, the interface 160 may provide a “mode” for enabling the “frame change rate” reduction feature, and a “mode” that disables such a feature.

The interface 160 may also provide a mode for selecting pieces of advertisement information, by which the controller 110 adjusts or otherwise changes the content or selected piece of advertisement information displayed at the movable apparatus 120 based on the geographical location of the movable apparatus 120. The interface 160 may also have a mode to disable such a feature.

When the mode for enabling the selection of content to be displayed based on geographical location of the movable apparatus 120, the controller 110 is enabled to select pieces of information based on the geographical information. For example, if a piece of information stored in storage 150 contains a geographical component that indicates that this piece of information is intended to be displayed within the beltway of the metropolitan Washington, D.C. area, and when the geographical location indicates that the movable apparatus 120 is within the beltway, the controller 110 may select this piece of information into a list of selected pieces of information that has priority to be displayed by the movable apparatus 120.

The interface 160 may enable a user to select the above-discussed modes by providing switches, buttons, touch screens, a display of a menu of options to be selected by pressing a key on a keyboard or by a click of a mouse when a pointer on the display is located at an intended selection displayed on the menu, or the like. The interface may be provided at the controller 110, or separately from the controller 110.

In FIG. 3, the display panel 205 may be provided such that the surface of the display panel 205 is parallel with the surface of the outer periphery of the movable apparatus 120, regardless whether the display panel 205 is an integral part of the periphery, a separate component fixedly provided on the periphery, replaceably attached to the periphery, or detachably attached to the periphery. For example, if the surface of the periphery of the movable apparatus is flat, the surface of the display panel 205 may also be flat. Alternatively, if at least a part of the periphery of the movable apparatus 120 is concave or convex, a corresponding portion of the display panel 205 may also be concave or convex accordingly, so that the display panel 205 contours the shape of the surface of the periphery of the movable apparatus 120.

Alternatively, the surface of the display panel 205 may follow a plane or contour different from that followed by the surface of the periphery of the movable apparatus 120. In particular, the display panel 205 may be at an angle or contour differently from the surface of the periphery of the movable apparatus 120. For example, when the periphery of the movable apparatus 120 is flat, the display panel 205 may be at an angle from the surface, regardless whether the display panel 205 is fixedly or detachably attached to the surface.

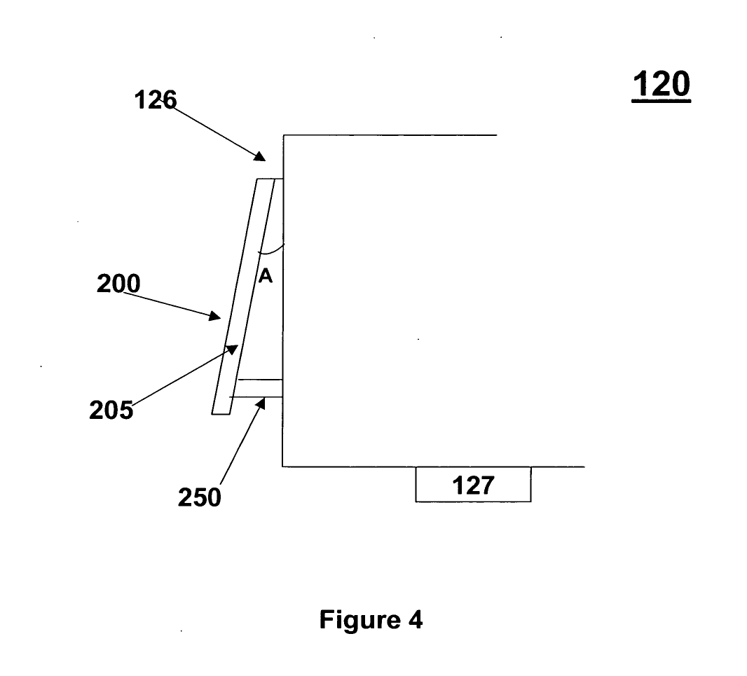

FIG. 4 illustrates an example in which a detachably attached display panel 205 is at an angle from the surface of the left-hand side portion 126 of the movable apparatus 120. As shown in FIG. 4, both the display panel 205 and the periphery at the left-hand side portion 126 are substantially flat. However, the display panel 205 is provided at an angle A from the surface of the left-hand side portion 126.

In FIG. 4, the angle A may be sustained by using a protrusion 250. The protrusion may be retrievable, such that the angle A may be adjusted. For example, the protrusion 250 may be completely retrieved, such that the angle A becomes zero, and the surface of the display panel 205 becomes substantially parallel with the surface of the left-hand side portion 126 of the movable apparatus 120.

In FIG. 4, the protrusion 250 is shown to be located near a lower portion of the display panel 205. However, the protrusion 250 may be also alternatively located near the upper portion of the display panel 205. Thus, the orientation of the display panel 205 may be changed from being tilted upward as shown in FIG. 4 to an orientation of being tilted downward.

Also, the protrusion 250 may be located near a side, such as a left-hand side or a right-hand side, of the display panel 205, such that the display panel may be tilted toward the front or rear of the movable apparatus 120.

In FIG. 4, only one protrusion 250 is shown. However, a plurality of protrusions (not shown) may be provided for easy or more sophisticated control of the orientation of the display panel 205. For example, a plurality of protrusions may be used such that the display panel 205 may be controlled to tilt both upward and frontward. The plurality of protrusions may be controlled so as to change the orientation of the display panel 205, as needed, during operation, such as when the movable apparatus 120 is moving.

As discussed above in connection with FIG. 3, the display assembly 200 may have a plurality of display panels 205. The contents displayed on the plurality of display panels 205 may be the same or different, depending on the control performed at the controller 110. For example, the contents displayed on the plurality of display panels 205 may be irrelevant with each other.

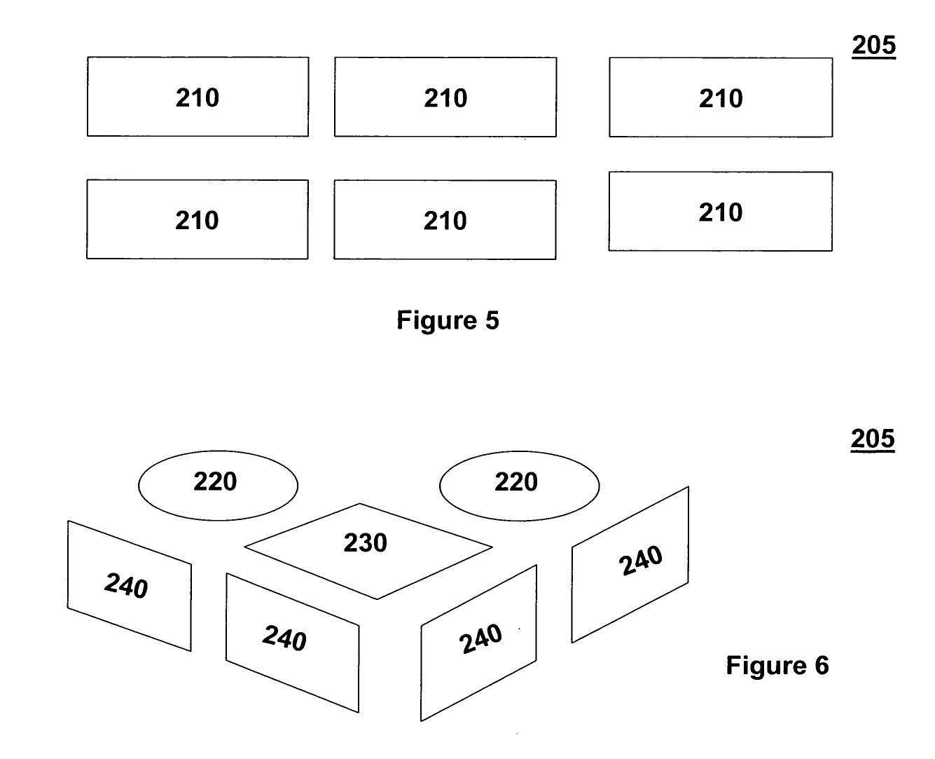

The display panel may include a singular display screen (FIG. 3) or a plurality of display screens. FIG. 5 illustrates an exemplary embodiment of a display panel 205 that includes a plurality of display screens. As shown in FIG. 5, the plurality of display screens 210 is arranged in a two-dimensional array, with each of the plurality of display screens 201 having at least one neighboring display screen in the horizontal direction and at least one neighboring display screen in the vertical direction. Each of the plurality of display screens 210 has a rectangular shape. The contents displayed on each of the plurality of display screens 210 may be the same or different, depending on the control of the controller 110. For example, the contents displayed on each of the plurality of display screens 210 may be irrelevant with each other. Alternatively and/or additionally, the contents displayed on the plurality of display screens 210 may form a sequence of a predetermined pattern, according to the control performed by the controller 110. For example, the six display screens 210 shown in FIG. 5 may each display one of different consecutive slides of a slide show. Also, the six display screens 210 may simultaneously display a video clip, with a second display screen 210 lagging the display of the first display screen 210 by a predetermined frame or temporal interval, with a third display screen 210 lagging the display of the second display screen 210 in a similar way, and so forth, such that a same frame of the video clip may repeat at the six display screens 210 with a delay therebetween.

The plurality of display screens of the display panel 205 may be in different arrangements or configurations. FIG. 6 illustrates another example of a plurality of display screens of the display panel 205. As shown in FIG. 6, the display panel 205 may have display screens 220-240 with various shapes and arranged in a particular configuration or pattern, which is different from that shown in FIG. 5.

In FIGS. 5 and 6, individual display screens may be individually controlled so as to have different orientation or tilt among themselves. For example, the upper row of display screens 210 may be controlled to tilt downward, while the lower row of display screens 210 may be controlled to tilt upwards.

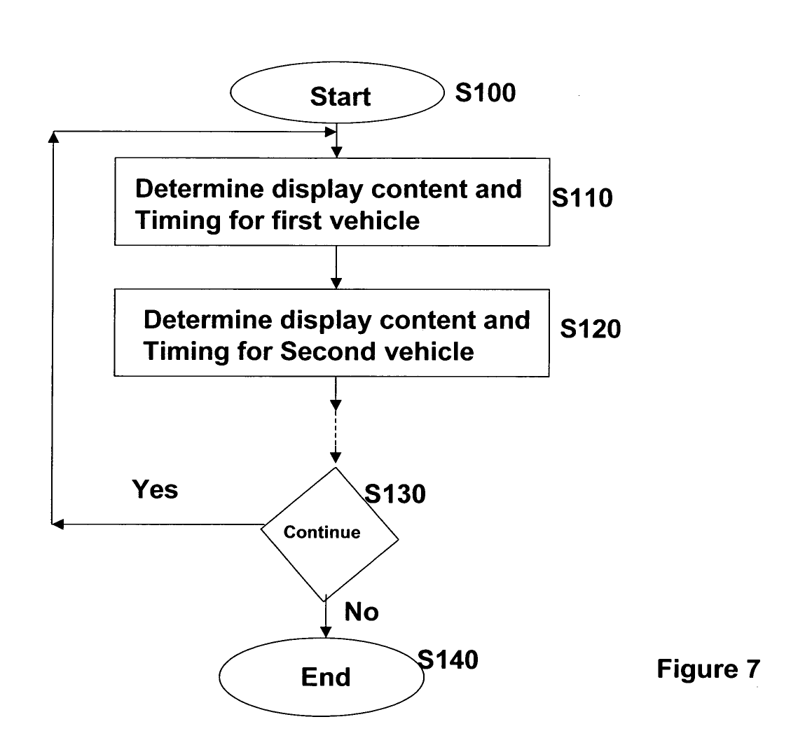

FIG. 7 is a flowchart illustrating an exemplary method for displaying advertisement information. As shown in FIG. 7, the method starts at step S100, and continues to step S110, where the content to be displayed at a first vehicle or movable apparatus and the timing of display are determined. Thereafter, the method continues to step S120, where the content to be displayed at a second vehicle or movable apparatus and the timing for such a display is determined. The method continues for all vehicles or movable apparatuses in the network controlled by a controller (FIG. 1). Thereafter, the method proceeds to step S130, where it is determined whether the determination processes need to continue. The determination processes need to continued if the contents displayed at the movable apparatuses are to be refreshed or otherwise changed. The determination processes do not need to continue, at least for a period of time, if the contents displayed at the movable apparatuses do not need to be changed within the period of time.

At step S130, if it is determined that the contents that are displayed and the timing for display need to be refreshed, the method returns to step S110. Otherwise, if a determination is made at step S130 that the display contents and the display timing do not need to be changed, at least temporarily, the method proceeds to step S140, where the method ends, at least for a period of time.

In the example shown in FIG. 7, different movable apparatuses within a networked advertisement system are coordinated. This method may be similarly used to coordinate the contents and timing of display of different display panels 205 within a display assembly 200 of a movable apparatus. This method may also be similarly applied for controlling different display screens 210-240 (FIGS. 5-6) of a display panel 205.

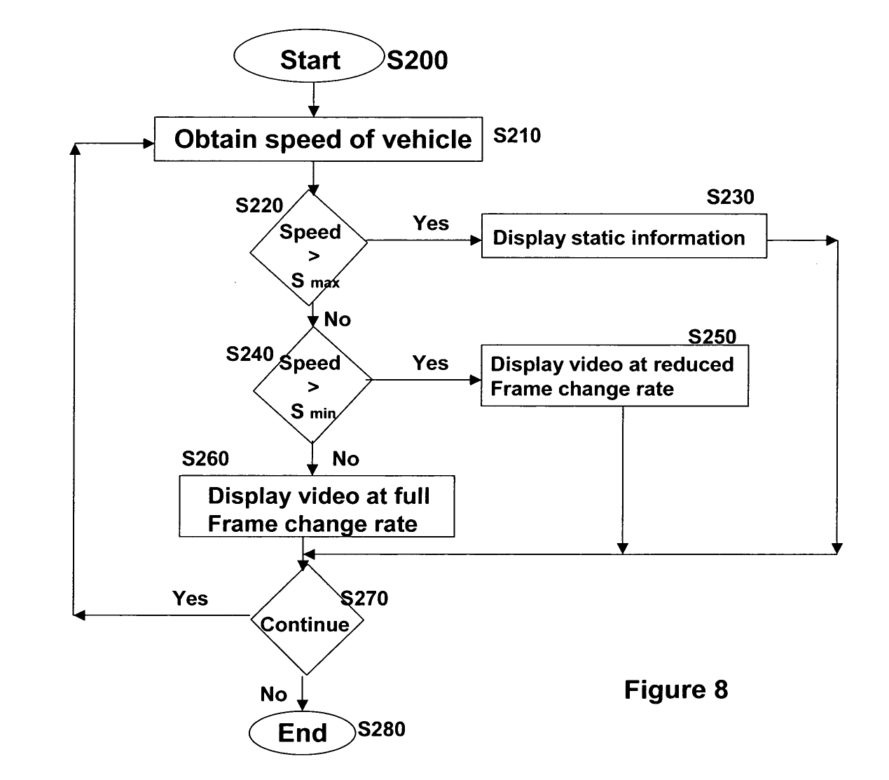

FIG. 8 is a flowchart illustrating another method for displaying advertisement information. As shown in FIG. 8, the method starts at step S200, and continues to step S210, where the controller 110 obtains the speed at which a vehicle or a movable apparatus is moving. Thereafter, the method proceeds to step S220, where a determination is made whether the speed is greater than a predetermined maximum speed Sₘₐₓ. The predetermined maximum speed may be 30 mph.

If it is determined at step S220 that the speed of the movable apparatus is greater than the maximum speed, the method proceeds to step S230, where the controller selects a static piece of advertisement information to display at the moveable apparatus. If a video clip is currently played at the movable apparatus, the controller reduces the frame change rate to zero so that the movie clip “freezes” at a frame. Thereafter, the method proceeds to step S270.

On the other hand, if it is determined at step S220 that the speed of the movable apparatus is less than the maximum speed, the method continues to step S240, where it is determined whether the speed of the movable apparatus is greater than a minimal speed Sₘᵢₙ. The minimal speed may be predetermined at 5 mph.

If it is determined at step S240 that the speed of the movable apparatus is greater than the minimal speed, the controller may decide to reduce the frame change rate of a video clip, if the video clip is currently displayed at the movable apparatus. The controller may also reduce the frame change rate of an animated slide sequence, if the animated slide sequence is being currently displayed at the movable apparatus. Thereafter, the method continues to step S270.

On the other hand, if it is determined at step S240 that the speed of the movable apparatus is less than the minimal speed, the method moves onto step S260, where the controller does not change any frame change rate. For example, the controller will continue to display a video clip at the full frame change rate, if the video clip is currently displayed at the movable apparatus. Thereafter, the method continues to step S270.

At step S270, it is determined whether the speed of the apparatus needs to be obtained again so as to refresh the above-discussed determination based on the speed of the movable apparatus. If it is determined that the speed of the movable apparatus needs to be obtained again, the method returns to step S210. Otherwise, the method proceeds to step S280, where the method ends.

In FIG. 8, only a maximum speed and a minimum speed are used. However, as discussed above, one or more intermediate speed thresholds may also be added so as to reduce a frame change rate at different levels.

The method shown in FIG. 8 is discussed in the context of making decisions based on the speed of a movable apparatus. This method may also similarly apply for making decisions based on the weather conditions experienced by a movable apparatus. For example, the weather conditions, such as foggy/rainy/sunny/snowy conditions, may be used to determine visibility or a visibility parameter that may be used in determining reduction of the frame change rate. The reduction of frame change rate may also be applied to a non-movable apparatus when the non-movable apparatus has a weather monitor. Also, the method may be similarly applied for making decisions based on both the speed of the movable apparatus and the weather conditions experienced by the movable apparatus.

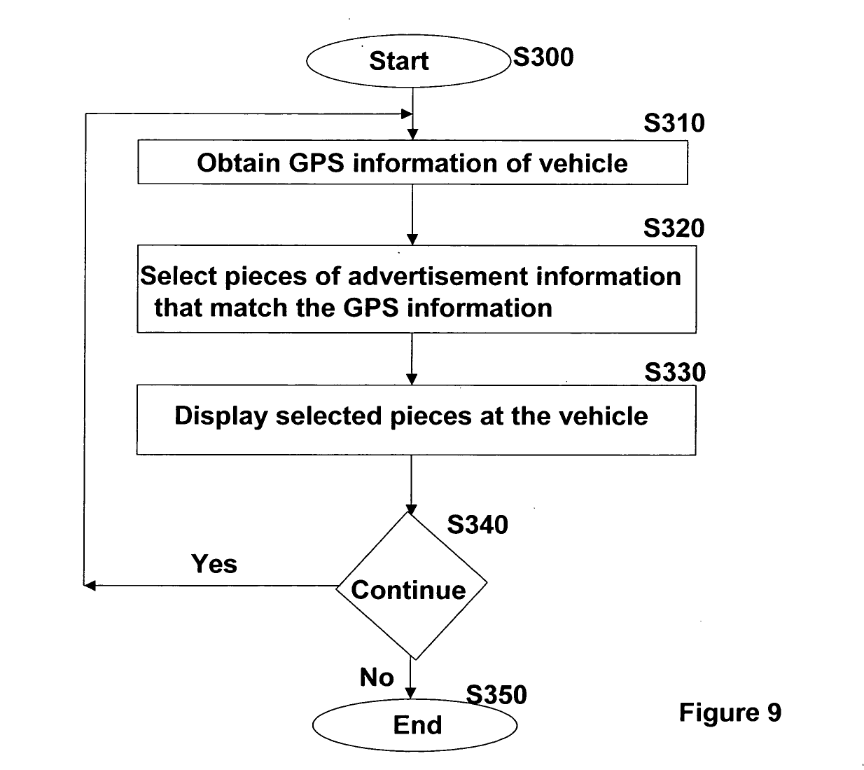

FIG. 9 is a flowchart illustrating another exemplary method for displaying advertisement information. As shown in FIG. 9, the method starts at step S300, and proceeds to step S310, where the GPS information or geographical location information of a vehicle or movable apparatus is obtained. Thereafter, the controller selects pieces of advertisement information that match the GPS information. The selection may be performed using the geographical component of the pieces of advertisement information stored in storage 150 (FIG. 1). The selected pieces may be placed in a priority list to be displayed at the movable apparatus, when the movable apparatus is within a predetermined radius of a geographical location prescribed in the GPS information and/or the geographical components.

Then, the method proceeds to step S330, where the selected pieces of advertisement information, such as those placed in the priority list, are displayed at the movable apparatus. Thereafter, the method proceeds to step S340, where a determination is made whether to obtain GPS information again.

If it is determined at step S340 that the GPS information is to be obtained again so as to refresh the selection of the pieces of advertisement information, the method returns to step S310. On the other hand, if it is determined at step S340 that the GPS information does not need to be obtained again, the method proceeds to step S350, where the method ends.

The methods illustrated in FIGS. 7-9 may be implemented in a computer program product that can be executed on a computer. The computer program product may be a computer-readable recording medium on which a control program is recorded, embedded or otherwise stored, or it may be a transmittable carrier wave in which the control program is embodied as a data signal.

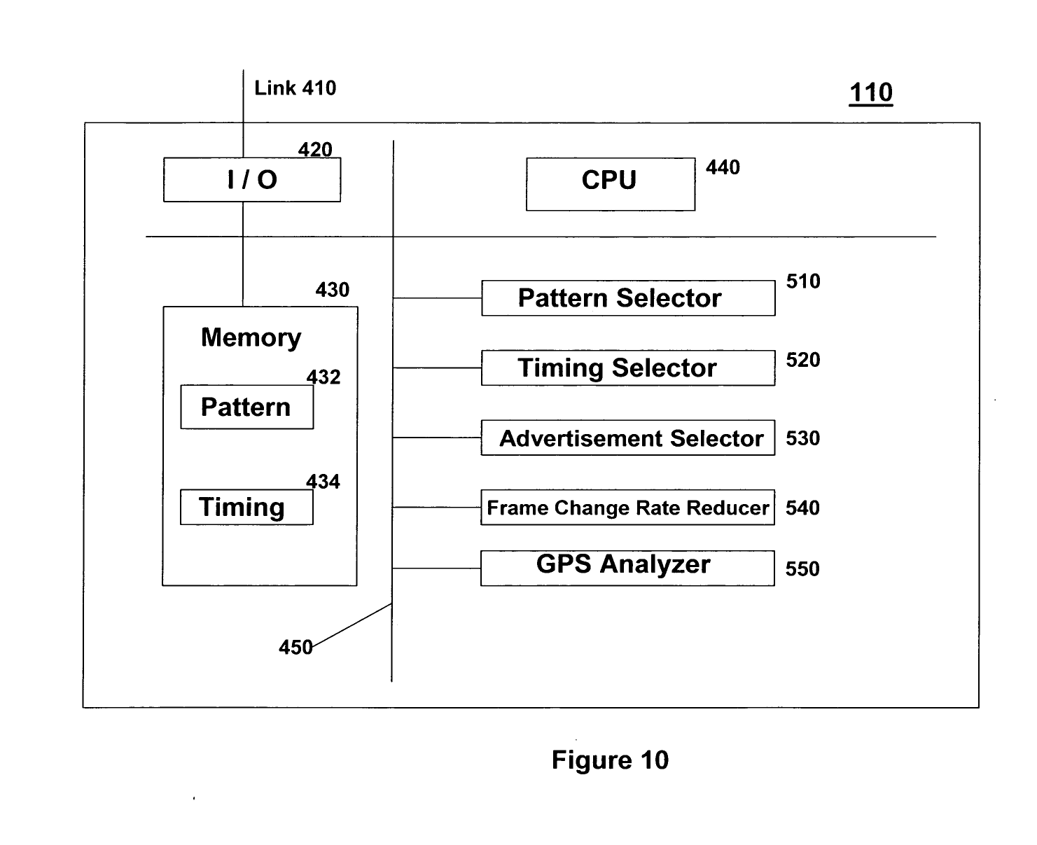

FIG. 10 is a functional block diagram of an exemplary embodiment of the controller 110 shown in FIG. 1. The controller 110 may reside in a server.

As shown in FIG. 10, the controller 110 may include an input/output (I/O) interface 420, a CPU 440, a memory 430, a pattern selector 510, a timing selector 520, an advertisement information selector 530, a frame change rate reducer 540, and a GPS analyzer 550, each interconnected by one or more control and/or data buses and/or application programming interfaces 450.

In various exemplary embodiments, the controller 110 is implemented on a programmable general purpose computer. However, the controller 110 can also be implemented on a special purpose computer, a programmed microprocessor or microcontroller and peripheral integrated circuit elements, an ASIC or other integrated circuits, a digital signal processor (DSP), a hard wired electronic or logic circuit, such as a discrete element circuit, a programmable logic device such as a PLD, PLA, FPGA or PAL, or the like. In general, any device capable of implementing a finite state machine that is in turn capable of implementing the flowchart shown in FIGS. 7-9 can be used to implement the controller 110.

The input/output interface 420 interacts with the outside of the controller 110. For example, the input/output interface 420 may receive input from the outside, via a link or an antenna 410, to receive information from one or more movable and non-movable apparatuses 120-140. The input/output interface 420 may also output data, such as selected advertisement information for delivery or transmission via the link and/or an antenna 410 to one or more movable and non-movable apparatuses 120-140. The input/output interface 420 may also receive advertisement information from storage 150.

The memory 430 may store any data and/or program necessary for implementing the functions of the controller 110. The memory 430 can be implemented using any appropriate combination of alterable, volatile, or non-volatile memory or non-alterable or fixed memory. The alterable memory, whether volatile or non-volatile, can be implemented using any one or more of static or dynamic RAM, a floppy disk and a disk drive, a writable or rewritable optical disk and disk drive, a hard drive, flash memory, or the like. Similarly, the non-alterable or fixed memory can be implemented using any one or more of ROM, PROM, EPROM, EEPROM, an optical ROM disk, such as a CD-ROM or a DVD-ROM disk and disk drive, or the like.

The memory 430 may contain pattern information 432. The pattern information 432 may include a list of patterns in which displays at different movable apparatuses, displays at different display panels of a display assembly, or displays at different display screens of a display panel, may be coordinated. The memory 430 may also include timing 434, which may include timing information for coordinating the displays.

The CPU 440 controls and/or accesses the input/output interface 420, the memory 430, the pattern selector 510, the timing selector 520, the advertisement information selector 530, the frame change rate reducer 540 and the GPS analyzer 550. The pattern selector 510, the timing selector 520, the advertisement information selector 530, the frame change rate reducer 540 and the GPS analyzer 550 each functions under the control of the CPU 440.

The pattern selector 510 selects a pattern from the pattern information 432, so that the controller 110 may coordinate the contents to be displayed at different movable and non-movable apparatuses, at different display screens, and at different display panels. The timing selector 520 functions to select timing information 434 for the controller 110 to control different times of the contents displayed at the different movable and non-movable apparatuses, the different display panels, and/or the different display screens. The timing information and the pattern information, when integrated, assist the contents to be coordinated into desired sequences at the different apparatuses, display panels and display screens.

The advertisement information selector 530 selects a particular piece of advertisement information to be displayed at a particular apparatus. The selection may be based on a number of factors. For example, the selection may be based on the geographical location of the movable apparatus, the weather conditions experienced by the movable or non-movable apparatuses, and/or based on the time of the day. Also, the selection may be based on requirements set forth by the party who paid for or otherwise endorsed the display of the piece of advertisement information.

The frame change rate reducer 540 functions to determine whether to reduce the frame change rate of a video clip and/or a slide sequence based on the speed in which a movable apparatus is moving at and/or the weather condition experienced by a movable apparatus or non-movable apparatus, received at the input/output interface 420. If a reduction is determined as needed, the frame change rate reducer reduces the frame change rate so as to assure readability of the displayed content to public viewers.

The GPS analyzer 550 functions to analyze the GPS information received from the input/output interface 420, so as to determine whether a particular piece of advertisement information should be placed on a priority list based on, for example, the match between the GPS information and the geographical location information indicated in the geographical component of a piece of advertisement information. If so, the GPS analyzer provides the information to the advertisement information selector 530 to make such a placement.

It will be appreciated that a variety of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. An advertisement system for displaying advertisement information, comprising:
a first movable apparatus that is configured to move at various speeds from various starting locations to various ending locations along various routes, the first movable apparatus including:
a first front portion;
a first rear portion that is opposite to the first front portion;
a first left-hand side portion on a left-hand side periphery of the first movable apparatus between the first front portion and first rear portion, and
a first right-hand side portion on a right-hand side periphery of the first movable apparatus between the first front portion and first rear portion,
wherein at least one of the first front portion, the first rear portion, the first left-hand side portion and the first right-hand side portion is provided with a first display assembly, the first display assembly having at least one first display screen, and
wherein the at least one first display screen faces away from the first movable apparatus and displays advertisement information for public viewers outside the first movable apparatus to view;
a storage that stores a plurality of pieces of advertisement information; and
a controller that selects a first piece of advertisement information from the plurality of pieces of advertisement information for the first display assembly to display on the at least one first display screen,
wherein the first piece of advertisement information is irrelevant to the starting locations, the ending locations, and the routes of the first movable apparatus.

2. The advertisement system as set forth in claim 1, wherein the first movable apparatus is an automobile vehicle or a boat.

3. The advertisement system as set forth in claim 1, wherein the at least one first display assembly includes a plurality of first display screens each facing away from the first movable apparatus and displaying advertisement information for public viewers outside the first movable apparatus to view.

4. The advertisement system as set forth in claim 3, wherein a first one of the plurality of first display screens displays advertisement information different from that displayed on a second one of the plurality of first display screens.

5. The advertisement system as set forth in claim 1, wherein the controller is mounted on the first movable apparatus.

6. The advertisement system as set forth in claim 1, wherein the controller resides at a location that is remote from the first movable apparatus, the first movable apparatus further including a first communication device to communicate with the controller for controlling the first display assembly.

7. The advertisement system as set forth in claim 1, further comprising:
a second movable apparatus that is configured to move at various speeds, the second movable apparatus including:
a second front portion;
a second rear portion that is opposite to the second front portion;
a second left-hand side portion on a left-hand side periphery of the second movable apparatus between the second front portion and second rear portion, and
a second right-hand side portion on a right-hand side periphery of the second movable apparatus between the second front portion and second rear portion,
wherein at least one of the second front portion, the second rear portion, the second left-hand side portion and the second right-hand side portion is provided with a second display assembly, the second display assembly having at least one second display screen, and
wherein the at least one second display screen faces away from the second movable apparatus and displays advertisement information for public viewers outside the second movable apparatus to view,
wherein the controller selects a second piece of advertisement information from the plurality of pieces of advertisement information for the second display assembly to display on the at least one second display screen, and
wherein the controller coordinates contents of the first and second pieces of advertisement information and times to display the first and second pieces of advertisement information between the at least one first display screen and the at least one second display screen.

8. The advertisement system as set forth in claim 1, wherein:
the advertisement information includes contents that promote a product, a service or a cause;
the advertisement information contains at least one of:
commercial information for promoting a product or a service;
political information for promoting a political campaign or a political figure;
civic information for promoting a civic event;
religious information for promoting a faith; and
ideological information for promoting a humanitarian cause or protection of environment;
the advertisement information is displayed in a form of at least one of text, image, video, audio, and animation,
the at least one first display screen is shaped as a rectangle, square, diamond, ellipse, or sphere, and
the at least one first display screen is a plasma display, a liquid crystal display, or an LED display.

9. The advertisement system as set forth in claim 1, wherein:
the controller selects an animated piece of advertisement information to display on the first display screen, the animated piece of advertisement information containing a plurality of frames and having a predetermined frame change rate when displayed; and
the controller adjusts the predetermined frame change rate based on one of: 1) a speed at which the first movable apparatus moves; or 2) weather conditions the first movable apparatus experiences.

10. The advertisement system as set forth in claim 9, wherein:
the controller controls the display assembly to display the animated piece of advertisement information at the predetermined frame change rate when the speed of the first movable apparatus is less than 5 mph, and controls the display assembly to display the animated piece of advertisement information with the frame change rate reduced to zero when the speed of the first movable apparatus is more than 30 mph.

11. The advertisement system as set forth in claim 1, further comprising:
a GPS information receiver that receives instant geographical location information of the first movable apparatus, wherein:
each piece of the plurality pieces of advertisement information contains a geographical component that indicates geographical locations at which a piece of advertisement information is intended to be displayed; and
the controller selects advertisement information to display based on the GPS information and the geographical components of the plurality of pieces of advertisement information.

12. The advertisement system as set forth in claim 11,
wherein the first movable apparatus is provided with an odometer and a navigation system,
wherein the GPS information receiver uses the navigation system to receive the geographical location information, and
wherein the controller uses data from the odometer to determine the speed of the first movable apparatus.

13. A method for displaying advertisement information, comprising:
selecting a first piece of advertisement information from a plurality of pieces of advertisement information stored in a searchable database at a storage; and
displaying the first piece of advertisement information on a first movable apparatus for public viewers outside the first movable apparatus to view,
wherein the first movable apparatus is configured to move at various speeds from various starting locations to various ending locations along various routes, the first movable apparatus including:
a first front portion;
a first rear portion that is opposite to the first front portion;
a first left-hand side portion on a left-hand side periphery of the first movable apparatus between the first front portion and first rear portion, and
a first right-hand side portion on a right-hand side periphery of the first movable apparatus between the first front portion and first rear portion,
wherein the first piece of advertisement information is displayed on a first display screen provided on at least one of the first front portion, the first rear portion, the first left-hand side portion and the first right-hand side portion,
wherein the at least one first display screen faces away from the first movable apparatus for public viewers outside the first movable apparatus to view, and
wherein the first piece of advertisement information is irrelevant to the starting locations, the ending locations, and the routes of the first movable apparatus.

14. The method as set forth in claim 13, further comprising:
selecting a second piece of advertisement information from the plurality of pieces of advertisement information;
displaying the second piece of advertisement information on a second movable apparatus for public viewers outside the second movable apparatus to view, wherein the second movable apparatus is configured to move at various speeds, the second movable apparatus including:
a second front portion;
a second rear portion that is opposite to the second front portion;
a second left-hand side portion on a left-hand side periphery of the second movable apparatus between the second front portion and second rear portion, and
a second right-hand side portion on a right-hand side periphery of the second movable apparatus between the second front portion and second rear portion,
wherein the second piece of advertisement information is displayed on a second display screen provided on at least one of the second front portion, the second rear portion, the second left-hand side portion and the second right-hand side portion, and
wherein the at least one second display screen faces away from the second movable apparatus for public viewers outside the second movable apparatus to view;
coordinating selection of contents of the first piece of advertisement information and the second piece of advertisement information; and
coordinating timing for displaying the first piece of advertisement information and the second piece of advertisement information between the at least one first display screen and the at least one second display screen.

15. The method as set forth in claim 13, further comprising:
selecting an animated piece of advertisement information to display on the first display screen, the animated piece of advertisement information containing a plurality of frames and having a predetermined frame change rate when displayed; and
adjusting the predetermined frame change rate based on a speed at which the first movable apparatus moves.

16. The method as set forth in claim 1, further comprising:
receiving GPS information to obtain instant geographical location information of the first movable apparatus,
providing a geographical component for each piece of the plurality pieces of advertisement information, the geographical component indicating geographical locations at which a piece of advertisement information is intended to be displayed; and
selecting advertisement information to display based on the GPS information and the geographical components of the plurality of pieces of advertisement information.

17. A computer-readable storage medium having a computer-executable program embedded thereon, the program, when executed on a computer, providing instructions for:
selecting a first piece of advertisement information from a plurality of pieces of advertisement information stored in a searchable database at a storage; and
displaying the first piece of advertisement information on a first movable apparatus for public viewers outside the first movable apparatus to view,
wherein the first movable apparatus is configured to move at various speeds from various starting locations to various ending locations along various routes, the first movable apparatus including:
a first front portion;
a first rear portion that is opposite to the first front portion;
a first left-hand side portion on a left-hand side periphery of the first movable apparatus between the first front portion and first rear portion, and
a first right-hand side portion on a right-hand side periphery of the first movable apparatus between the first front portion and first rear portion,
wherein the first piece of advertisement information is displayed on a first display screen provided on at least one of the first front portion, the first rear portion, the first left-hand side portion and the first right-hand side portion,
wherein the at least one first display screen faces away from the first movable apparatus for public viewers outside the first movable apparatus to view, and
wherein the first piece of advertisement information is irrelevant to the starting locations, the ending locations, and the routes of the first movable apparatus.

18. The computer-readable storage medium as set forth in claim 17, the program providing further instructions for:
selecting a second piece of advertisement information from the plurality of pieces of advertisement information;
displaying the second piece of advertisement information on a second movable apparatus for public viewers outside the second movable apparatus to view, wherein the second movable apparatus is configured to move at various speeds, the second movable apparatus including:
a second front portion;
a second rear portion that is opposite to the second front portion;
a second left-hand side portion on a left-hand side periphery of the second movable apparatus between the second front portion and second rear portion, and
a second right-hand side portion on a right-hand side periphery of the second movable apparatus between the second front portion and second rear portion,
wherein the second piece of advertisement information is displayed on a second display screen provided on at least one of the second front portion, the second rear portion, the second left-hand side portion and the second right-hand side portion, and
wherein the at least one second display screen faces away from the second movable apparatus for public viewers outside the second movable apparatus to view;
coordinating selection of contents of the first piece of advertisement information and the second piece of advertisement information; and
coordinating timing for displaying the first piece of advertisement information and the second piece of advertisement information between the at least one first display screen and the at least one second display screen.

19. The computer-readable storage medium as set forth in claim 17, the program providing further instructions for:
selecting an animated piece of advertisement information to display on the first display screen, the animated piece of advertisement information containing a plurality of frames and having a predetermined frame change rate when displayed; and
adjusting the predetermined frame change rate based on a speed at which the first movable apparatus moves.

20. The computer-readable storage medium as set forth in claim 17, the program providing further instructions for:
receiving GPS information to obtain instant geographical location information of the first movable apparatus,
providing a geographical component for each piece of the plurality pieces of advertisement information, the geographical component indicating geographical locations at which a piece of advertisement information is intended to be displayed; and
selecting advertisement information to display based on the GPS information and the geographical components of the plurality of pieces of advertisement information.
